(19) United States
(12) Patent Application Publication
(10) Pub. No.: US 2014/0347165 A1
(43) Pub. Date: Nov. 27, 2014

(54) RFID TAG RANGE CONTROL

(71) Applicant: HAND HELD PRODUCTS, INC., Fort Mill, SC (US)

(72) Inventor: Edward C. BREMER, Victor, NY (US)

(73) Assignee: HAND HELD PRODUCTS, INC., Fort Mill, SC (US)

(21) Appl. No.: 13/901,106

(22) Filed: May 23, 2013

(51) Int. Cl. G06K 7/10

(52) U.S. Cl. CPC G06K 7/10217
USPC 340/10.1

(57) ABSTRACT

Methods and systems of processing transponder signals received from transponders to identify the transponders are provided. A first signal having a first signal strength is received from a first transponder, and a reference signal strength is determined based on the first signal strength. A second signal having a second signal strength is received from a second transponder. The reference signal strength is compared with the second signal strength. The first transponder is determined to be within a predefined range based on the second signal strength being greater than the reference signal strength.

### BACKGROUND

Systems which employ radio frequency identification (RFID) technology are currently used to recognize and/or to identify all types of objects bearing an adapted RFID tag. In this regard, an RFID reader may be placed in an area which has several RFID tags and would read all of the RFID tags whose range extends to the RFID reader even if some of the RFID tags may not be desired to be read. For example, if it is desired for a RFID reader to read only RFID tags in a shopping cart, the RFID reader may still read RFID tags in another shopping cart due to the proximity thereof. In this regard, the depth of the field of view of an RFID reader can create issues by reading undesired RFID tags.

### SUMMARY

To address the above issues, an RFID system is provided where one or more specifically-dedicated reference tags may be arranged around the RFID tag reader to provide a reference distance to the RFID tag reader. The RFID tag reader can read the reference tag(s) and establish a reference distance by using the receiver signal strength level. Once the signal strength level is established, only RFID tags that meet predefined signal strength criteria are read while the RFID tags which do not need such criteria may not be read or processed.

In one embodiment, a method of processing transponder signals received from transponders to identify the transponders is provided. A first signal having a first signal strength is received from a first transponder, and a reference signal strength is determined based on the first signal strength. A second signal having a second signal strength is received from a second transponder. The reference signal strength is compared with the second signal strength. The first transponder is determined to be within a predefined range based on the second signal strength being greater than the reference signal strength.

In another embodiment, an RFID system may include an antenna and The processer may be configured to receive, from a reference transponder, a first signal having a first signal strength; determine a reference signal strength based on the first signal strength; receive, from a first transponder, a second signal having a second signal strength; and compare the reference signal strength with the second signal strength; and determine that that the first transponder is within a predefined area in response to the second signal strength being greater than the reference signal strength.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of embodiments of the invention. In the drawings, like numerals are used to indicate like parts throughout the various views.

FIG. 1 illustrates a method of an RFID system identifying transponders within a predefined area in accordance with one embodiment.

FIG. 2 illustrates an example of an RFID system identifying transponders within a predefined area, according to one embodiment.

FIG. 3 illustrates another RFID system identifying transponders within a predefined area, according to another embodiment.

FIG. 4 is a system diagram of an RFID system identifying transponders within a predefined area according to an embodiment.

FIG. 5 illustrates yet another RFID system identifying transponders within a predefined area, according to another embodiment.

FIG. 6 illustrates still yet another RFID system identifying transponders within a predefined area, according to yet another embodiment.

### DETAILED DESCRIPTION OF THE EMBODIMENTS

Various examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the invention. Certain terms may even be emphasized below; however, any terminology intended to be interpreted in any restricted manner will be overtly and specifically defined as such in this Detailed Description section.

Examples of the invention include various methods and apparatuses for defining an area where an RFID reader identifies transponders within the predefined area as well as any transponders outside of the predefined area.

Examples of the invention find ready application in settings where transponders are placed on objects, such as inventory. These settings may include, for example, supermarkets, retail stores, and any other area.

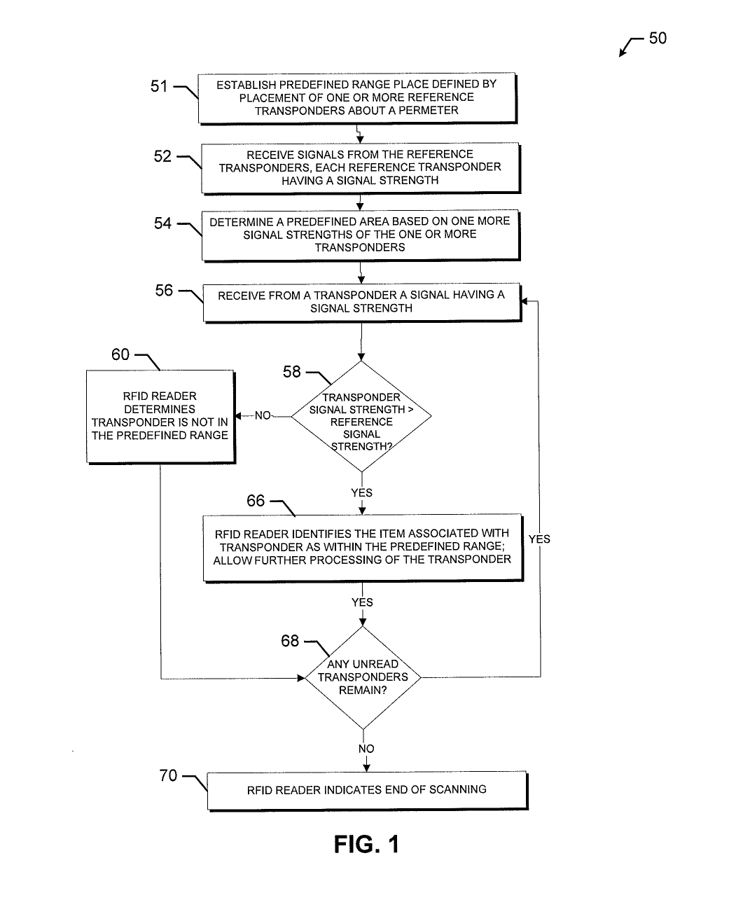

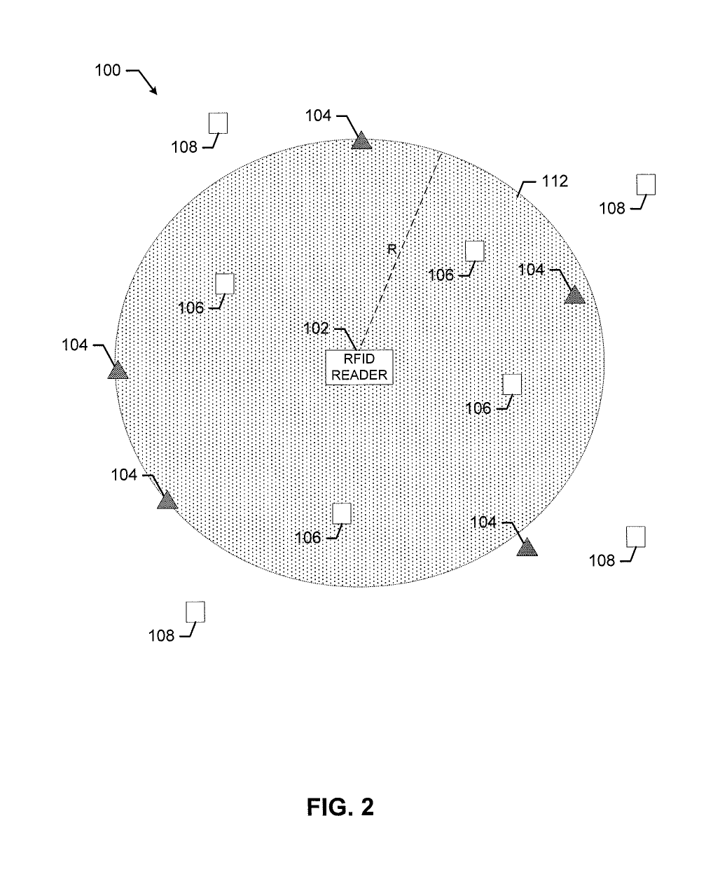

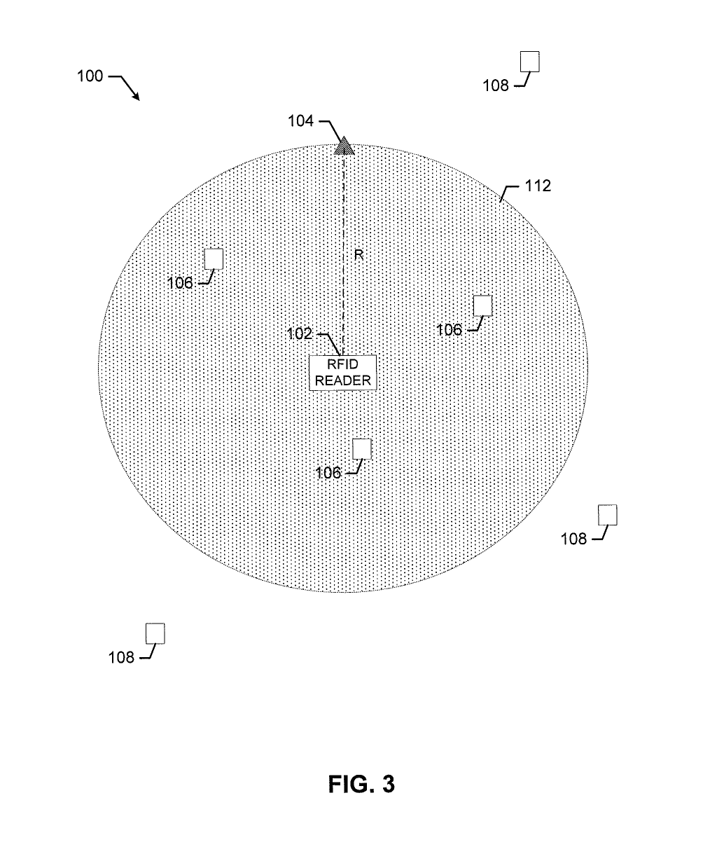

FIG. 1 illustrates a method 50 of an RFID system identifying transponders within a predefined area in accordance with one embodiment. The method 50 of FIG. 1 is discussed below along with FIGS. 2-3.

At block 51 of FIG. 1 and as illustrated in FIG. 2, a predefined area 101 is defined by the placement one or more reference transponders 104 about a perimeter 112. The predefined area 101 is an area in which only transponders 106 therein will be read and processed.

The reference transponders 104 are special transponders that the RFID reader identifies as transponders to define the perimeter 112. For example, the reference transponders 104 may have identifiers which are identified in the RFID reader as reference identifiers.

At block 52, the RFID reader reads signals from reference transponders. To determine that the transponder is a reference transponder, an identifier of the received transponder signal is read and compared with a database of transponder identifiers. If the transponder identifier in the database indicates the transponder as a reference transponder, the signal strength from the reference transponder 104 is recorded. Otherwise, the transponder is processed according to blocks 56-70.

At block 54 of FIG. 1, the RFID reader determines a predefined area or range based on signal strengths of the reference transponders. The RFID reader may determine an overall reference signal strength based on the number of reference transponders. In an embodiment, as illustrated in FIG. 3, there may be only a single reference transponder 304, and as such, the overall reference signal strength is equal to the signal strength of the reference transponder 304. The predefined area 101 may be an area that is within a perimeter 112 having a radius R in all directions about the RFID reader 102. In this regard, transponders 106 are within the predefined area 101 but transponders 108 are outside of the predefined area 101.

In the embodiment illustrated by FIG. 2, there may be multiple reference transponders 104 placed around the perimeter 112 of the RFID reader 102. In this regard, in response to the RFID reader 102 receiving signals from the multiple reference transponders 104, the signal strength of each reference transponder 104 is detected and then stored on the RFID reader 102. The RFID reader 102 then uses the reference transponders' signal strengths to determine a predefined area. For example, the predefined area or range may be determined by determining an overall reference signal strength. The overall reference signal strength may be determined to be an average of the reference transponders' signal strengths, the maximum signal strength of the reference transponders, the minimum received signal strength of the reference transponders, or any other calculation based on the reference transponders' signal strengths.

Once the reference signal strength is determined, the predefined area 101 may be the area within (or possibly outside of) a perimeter 112 defined by a radius R. Accordingly, the predefined area or range may be a circular area with the RFID reader being proximate to the center of the circular area as illustrated in FIGS. 2-3. In this regard and similar to FIG. 3, transponders 106 are within the predefined area 101 but transponders 108 are outside of the predefined area 101.

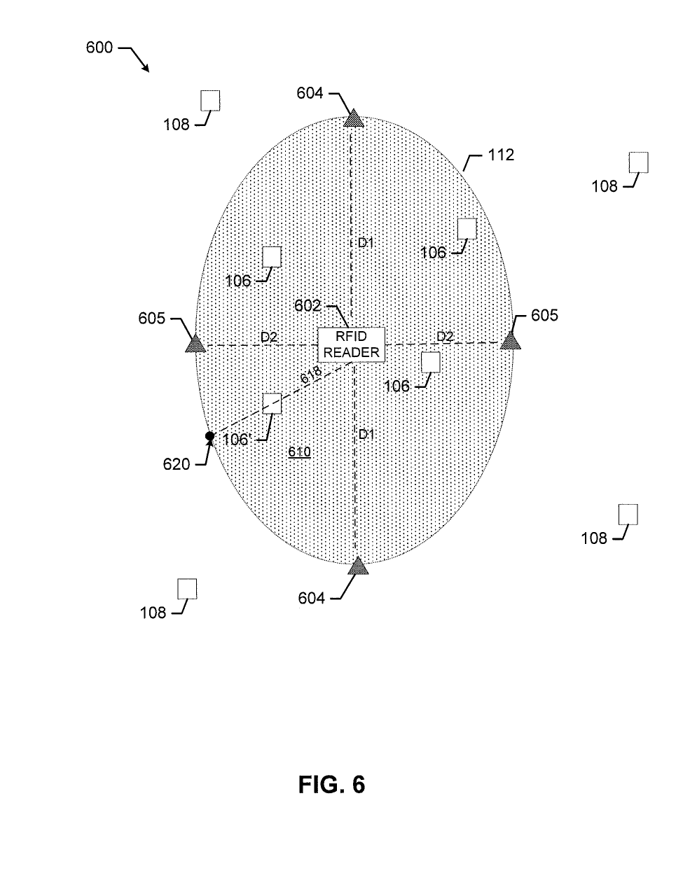

In another embodiment, the predefined area or range is determined by determining the reference signal strengths of each reference transponder as well as the radial distance or location of each reference transponder. This provides an effective distance (e.g., signal level strength) and direction (e.g., radial distance) of a of each reference transponder to determine a perimeter of the predefined area. This is discussed more later with regard to FIG. 6.

In one embodiment, each reference transponder may have a weighted or prioritized value. In this regard, should there be a conflict in values, the reference transponder that has the weighted value will take priority over the a reference transponder having a lower weighted value. In another embodiment, the overall reference signal strength may be calculated using the weighted values of the reference transponders along with the signal strengths of the reference transponders. For example, if reference transponder A has a signal strength of 10 and a weighting value of 5 and reference transponder B has a signal strength of 20 and a weighted value of 15, instead of a straight average of signal strengths (which would be 15), the weighted averages would be an average of the summation of each product of the weighted values and signal strengths (in this example, ((10×5)+(20×15))/(15+5)=17.5). In this regard, one can weight the transponders which he knows is more accurate than other transponders (e.g., if that transponder has an unimpeded path to the RFID reader, is more reliable in general, is at a specific desired distance, etc.).

At block 56 of FIG. 1, the RFID reader receives signals from transponders which the RFID reader determines are not reference transponders (i.e., the identifier of the transponder does not match the pre-stored identifiers associated with the reference transponders). For this, the RFID reader 102 detects the signal strength from the non-reference transponder and compares such signal strength of the non-reference transponder to the reference signal strength (block 58). If the non-reference transponder signal strength is greater than the reference signal strength, the RFID reader determines that the non-reference transponder is within the predefined area 101 because such transponder is closer in proximity to the RFID reader 102 than the reference transponder 104 (block 66). If the non-reference transponder signal strength is less than the reference signal strength, the RFID reader determines that the non-reference transponder may not be within the predefined area 101 because such transponder is likely farther in proximity to the RFID reader 102 than the reference transponder 104 (block 60).

The signal strength measured may be the received signal strength indicator (RSSI), which is a measurement of the power present in a received radio signal. RSSI is the relative received signal strength in a wireless environment, in arbitrary units. RSSI is an indication of the power level being received by the antenna. Therefore, the higher the RSSI number (or less negative in some devices), the stronger the signal.

It should be understood that a transponder may be any device which is configured to transmit a code to a wireless reader, such as an RFID reader. In one embodiment, a transponder is an RFID tag, which may be used to automatically identify objects. RFID tags are generally placed on items using an automatic tag applicator, and then the items are identified by one or more RFID readers.

The RFID reader 102 continues to perform blocks 56-68 until all transponders have been read in the area. In one embodiment, the RFID reader can determine which transponders have been read by storing the identifier of each transponder and comparing such identifier with each transponder. If the identifier of the transponder has already been stored or marked as read on the RFID reader, the transponder may not be processed again. After all transponders have been read, the RFID reader 102 may cease scanning and provide a list of all items within the predefined area 101 on a display.

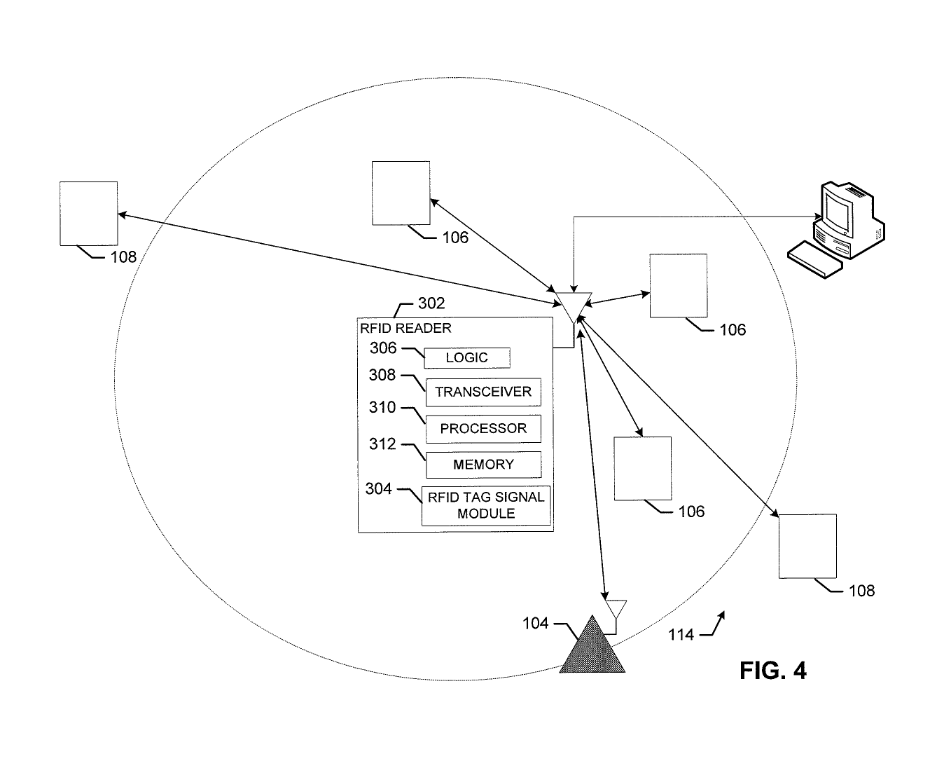

FIG. 4 is a system diagram of an RFID system 300 identifying transponders 106 within a predefined area 101 according to an embodiment. As illustrated, transponders 106 are within the predefined area 101 and transponders 108 are outside of the predefined area 101. The RFID system 300 may include an RFID reader return to and a computing system 301. The RFID reader 302 may contain at least one antenna 305, logic 306, a transceiver 308, a processor 310, memory 312, and an RFID tag signal module 314. The RFID reader 302 receives signals from all transponders through antenna 305 and transceiver 308. The processor 310 retrieves the signals received by transceiver 308 and temporarily stores the data (e.g., codes identifying the associated object, an identifier identifying the transponder, etc.) from the received signal into memory 312. The processor 310 then sends the signal to RFID tag signal module 314, which determines the signal strength thereof. The signal strength is then stored into memory and associated with the specific transceiver using the transceiver's identifier.

The logic 306 performs the tasks identified above with regard to blocks 58-66. For example, the logic 306 compares the signal strength of the transponder signal with the reference signal strength and returns a greater than or less than value. The logic 306 also excludes the transponders 108 having a signal strength that does not meet predetermined criteria (e.g., the signal strength is less than the reference signal strength) and also includes or stores data from the transponders 106 in memory which meet such predetermined criteria. The logic 306 may also determine the reference signal strength, especially if there are multiple reference transponders.

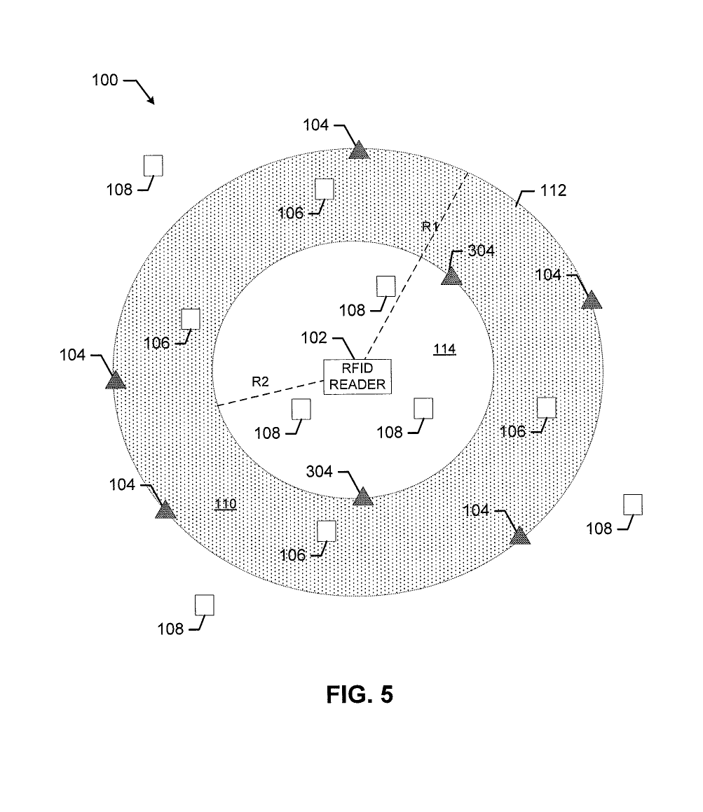

FIG. 5 illustrates yet another RFID system 500 identifying transponders 106 within a predefined area 110, according to another embodiment. As illustrated, one or more reference transponders 104 may be placed around the perimeter 112 of the RFID reader 102 similar to that discussed above for FIGS. 2-3. However, a second set of reference transponders 304 may be placed around a second perimeter of the RFID reader 102. In this regard, reference transponders 104 define a first boundary (e.g., an ending boundary) while reference transponders 304 define a second boundary (e.g., a starting boundary). The first set of reference transponders define a first radius R1 about RFID reader 102 and the second set of reference transponders define a second radius R2 about RFID reader 102. Radius R1 is determined based on a first reference signal strength from reference transponder(s) 104 and radius R2 is determined based on a second reference signal strength from reference transponder(s) 104, where the first and second reference signals are determined similar to that discussed above with regard to block 54 of FIG. 1.

The predefined area 110 may be the area extending past radius R2 but before radius R1 as illustrated in FIG. 5. These two sets of reference transponders 104, 304 define the second predefined area 110 whereby transponders 106 are located and will be read and processed, which the transponders 108 that are not within the second predefined area 110 (e.g., the transponders 108 in area 114 and the transponders 108 extending past the first boundary) may be read but not processed.

When a signal is received from a non-reference transponder, the signal strength of such transponder is compared with the first and second reference signal strengths to determine if the non-reference transponder signal strength is greater than the first reference signal strength but less than the second reference signal strength so that the effective distance from the RFID reader is between radius R1 and R2 from the RFID reader 102.

FIG. 6 illustrates yet another RFID system 600 identifying transponders within a predefined area, according to another embodiment. As illustrated, an RFID reader 602 is provided. RFID reader 602 may be configured to determine the direction from where reference RFID transponders are located. For example, RFID reader 602 may have one or more directional antennas that sweep a certain area so that when a reference RFID transponder 604, 605 is detected, the signal strength of each reference RFID transponder 604, 605 is determined. The system may determine the angle where the signal strength of the reference RFID transponder 604, 605 is greatest. The radial distance of each reference RFID transponder 604, 605 may be manually entered by a user during calibration.

As illustrated in FIG. 6, reference transponders 604 are located along a first axis D1, and reference transponders 605 are located along a second axis D2. In this regard, for example, reference transponders 604 may be located longitudinally along the length of a conveyor belt at a grocery store while reference transponders 605 may be located perpendicularly thereto at the cashier so as to measure the width of the conveyor belt. This allows the reference tags to pinpoint the conveyor belt (or other area) of a grocery store at checkout so that all items (i.e., 106) in that area will be scanned and processed but others (i.e. 108) outside such area are not scanned and processed.

Thus, the predefined area 610 of FIG. 6 is an oval shape. It should be understood that any shape may be formed by placing reference transponders at any location using an RFID reader which has directional capabilities.

In FIG. 6, the RFID reader 602 sweeps to search for RFID transponders. As a starting point, the RFID reader 602 may first sweep toward RFID transponder 605 on one side. The RFID reader 602 reads the signal level of the reference RFID transponder 605 and sets this threshold level at the angle thereof (whereby the angle may be manually entered into the RFID reader 602). The RFID reader 602 then may sweep in a clockwise manner to reference transponder 604 and determine the signal level of reference RFID transponder 604. The RFID reader 602 now has a second point on the predefined range 610 and may connect the two points together via an algorithm (e.g., a linear algorithm, a multi-degree algorithm, etc.). Regardless, the RFID reader 602 may continue to sweep in a clockwise manner and read the reference transponder 605 opposite of the first transponder 605 already read. The RFID reader 602 determines the signal level of such transponder and records such location (e.g., the radial angle which may be determined by the system or manually entered into the system by a user). The RFID reader then completes the sweep and detects the signal level of the last RFID transponder 604 (according to the example of FIG. 6). The RFID reader 602 then determines the predefined area by plotting points indicative of the locations and signal strengths of the reference transponders. The signal strengths correspond to the distance from the RFID reader (e.g., the lower the signal strength, the longer the distance from the RFID reader, etc.), while the radial angle of each reference transponder relates to a direction relative to the RFID reader. The points may then be connected using a programmed algorithm. In one embodiment, the points are linearly connected. In another embodiment, the points are all connected using a smoothing algorithm (e.g., an algorithm with an order greater than one). In this regard, as illustrated in FIG. 6, an oval shape is created by connecting the points using a second-order algorithm. The points along the perimeter of the oval shape (or whatever shape is created) relate to a signal strength threshold. Any transponder that has a signal strength that is greater than the signal strength threshold at a closest point on the perimeter will be read while those that has signal strength that is less than the signal strength threshold will not be read.

Any non-reference transponders may be read by the RFID reader and track the angle relative to the RFID reader in order to determine if the transponder is within the predefined area, discussed above. For example, the transponder may be determined to be in the predefined area if such transponder is determined to have a signal level that is higher than the signal level of a calculated signal level strength threshold for the angle of the RFID reader sweep at the point of detecting the transponder. Any transponders that have a signal level lower than the signal strength threshold relating to the respective point on the perimeter 112 of the predefined area (which corresponds to the predetermined threshold for that particular transponder) is determined to be outside of the predefined area and, as such, may not be read or the data associated therewith is not used in further processing.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the invention provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description describes certain embodiments of the invention, and describes the best mode contemplated, no matter how detailed the above appears in text, the invention can be practiced in many ways. Details of the system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such teens. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention may be recited as a means-plus-function claim under 35 U.S.0 sec. 112, sixth paragraph, other aspects may likewise be embodied as a means-plus-function claim, or in other forms, such as being embodied in a computer-readable medium. (Any claims intended to be treated under 35 U.S.C.§112, 6 will begin with the words “means for”.) Accordingly, the inventors reserve the right to add additional claims after filing the application to pursue such additional claim forms for other aspects of the invention.

What is claimed is:

1. A method of processing transponder signals received from transponders to identify the transponders, the method comprising:
receiving, from a reference transponder, a first signal having a first signal strength;
determining a reference signal strength based on the first signal strength;
receiving, from a first transponder, a second signal having a second signal strength;
comparing the reference signal strength with the second signal strength; and
determining that that the first transponder is within a predefined area in response to the second signal strength being greater than the reference signal strength.

2. The method of claim 1, further comprising determining that that the first transponder is outside of the predefined range in response to the second signal strength being less than the reference signal strength.

3. The method of claim 1, further comprising:
receiving a third signal from a second reference transponder, the third signal having a third signal strength;
wherein the determining the reference signal strength comprises one of the third signal strength or the first signal strength.

4. The method of claim 1, wherein the reference signal strength comprises the first signal strength.

5. The method of claim 1, wherein the determining a reference signal strength comprises defining the predefined area, wherein the reference signal strength defines a perimeter about the RFID reader such that any transponders within such perimeter has a detected signal strength greater than the reference signal strength and thus us within the predefined area.

6. A radio frequency identification system comprising:
an antenna;
a transceiver to transmit and receive signals from transponders;
a measurement device to measure a signal strength from each of the transponders; and
a processor configured to receive signals from the antenna through the transceiver and to receive measurement data from the measurement device, wherein the processor is configured to:
receive, from a reference transponder, a first signal having a first signal strength;
determine a reference signal strength based on the first signal strength;
receive, from a first transponder, a second signal having a second signal strength;
compare the reference signal strength with the second signal strength; and
determine that that the first transponder is within a predefined area in response to the second signal strength being greater than the reference signal strength.

7. The radio frequency identification system of claim 6, wherein the processor is further configured to determine that that the first transponder is outside of the predefined range in response to the second signal strength being less than the reference signal strength.

8. The radio frequency identification system of claim 6, wherein the processor is further configured to:
receive a third signal from a second reference transponder, the third signal having a third signal strength;
wherein the determining the reference signal strength comprises one of the third signal strength or the first signal strength.

9. The radio frequency identification system of claim 6, wherein the reference signal strength comprises the first signal strength.

10. The radio frequency identification system of claim 6, wherein the determining a reference signal strength comprises defining the predefined area, wherein the reference signal strength defines a perimeter about the RFID reader such that any transponders within such perimeter has a detected signal strength greater than the reference signal strength and thus us within the predefined area.

11. The radio frequency identification system of claim 6, wherein measurement device comprises logic which is configured to measure the signal strength from each of the transponders.

12. A method of processing transponder signals received from transponders to identify the transponders, the method comprising:
receiving, from a first reference transponder, a first signal having a first signal strength;
determining a first position of the first reference transponder;
associating a first reference signal strength using the first signal strength at the first position;
receiving, from a second reference transponder, a second signal having a second signal strength;
determining a second position of the second reference transponder;
associating a second reference signal strength using the second signal strength at the second position;
receiving, from a first transponder, a third signal having a third signal strength;
determining a location of the first transponder;
determining a predefined area defined by the first position and the second position; and
determining that that the first transponder is within the predefined area based on the third signal strength being greater than at least one of the first signal strength or the second signal strength.
